(19) United States
(12) Patent Application Publication
(10) Pub. No.: US 2015/0268200 A1
(43) Pub. Date: Sep. 24, 2015

(54) NONINVASIVE MEASURING METHOD FOR PROBING AN INTERFACE

(71) Applicant: NATIONAL TAIWAN UNIVERSITY, Taipei (TW)

(72) Inventors: CHI-KUANG SUN, TAIPEI (TW); CHIEN-CHENG CHEN, Taipei (TW); YU-CHIEH WEN, Taipei (TW)

(21) Appl. No.: 14/729,832

(22) Filed: Jun. 3, 2015

Related U.S. Application Data
(62) Division of application No. 13/563,467, filed on Jul. 31, 2012.

(51) Int. Cl. G01N 29/44; G01N 29/30; G01N 29/24

(52) U.S. Cl. CPC G01N 29/4436; G01N 29/2418; G01N 29/30; G01N 2291/022; G01N 2291/023; G01N 2291/015; G01N 2291/02818; G01N 2291/02827; G01N 2291/042

(57) ABSTRACT

The present disclosure provides solutions to probing an interface. With a noninvasive measuring device provided in one embodiment of the disclosure, an acoustic wave whose frequency is higher than approximately 300 GHz is generated to propagate in a buffering film. With measuring the reflection from the interface of an object to be measured interfacing with the buffering film, it is possible in one embodiment of the disclosure that at least one physical property of the interface may be analyzed, preferably with approximately 0.3 nm resolution.

### INCORPORATION BY REFERENCE

This patent application is a divisional of U.S. patent application Ser. No. 13/563,467, filed on Jul. 31, 2012, which are incorporated by reference along with all other references cited in this application.

### FIELD OF THE INVENTION

The present disclosure generally relates to a noninvasive measuring method for probing an interface, and more particularly, to a noninvasive measuring method for probing an interface through an acoustic wave.

### BACKGROUND OF THE INVENTION

Interfaces between two different materials or mixtures play important rolls in many situations for their physical properties. For example, the wetting of an interface between a solid and a fluid is important for controlling the progress of a chemical reaction. The physical and chemical properties of interfacial water existing within 45 Å, from the interface, are quite different from that of bulk water existing in the rest part that affect not only the wetting of surfaces, but also reactions of water purification, protein folding, hydrogen energy, and so on.

Currently, some approaches have been developed for probing interfacial water, such as atomic force microscopy, surface force apparatus, sum-frequency vibration spectroscopy, X-ray diffraction spectroscopy, ultrafast electron crystallography, low energy electron diffraction, scanning tunneling microscopy, neutron diffraction, nuclear magnetic resonance, and so on. Only the first two approaches listed above can probe the intermolecular interaction between interfacial water with a substrate, but both techniques are invasive. In addition, they are quasi-static measurements, inevitably facing the inability to picosecond-scale structural relaxation dynamics.

Therefore, there is still a need for developing a noninvasive technique for probing an interface in a shorter measuring time.

### SUMMARY OF THE INVENTION

An object of the present disclosure is to provide a noninvasive measuring method for probing an interface that measures the interface to analyze at least one physical property through acoustic waves. According to one embodiment of the disclosure, the noninvasive measuring method for probing an interface are versatile for an object of any state, including fluid, solid, and gas to obtain the analyzed physical property including, roughness, spectrum loss, mass density, elastic modulus, and bulk viscosity. According to another embodiment of the disclosure, the noninvasive measuring method for probing an interface could even measure the reflection of the acoustic wave with approximately 0.3 nm resolution.

In one aspect of the disclosure, an embodiment of the disclosure comprises a noninvasive measuring method for probing an interface, the method comprising the steps of: providing a transducer whose thickness is between approximately 1 nm to 10 nm and is covered by a buffering film to generate an acoustic wave with a frequency that is higher than approximately 300 GHz; calibrating with the measurement of the reflection of the acoustic wave reflecting at the surface of the buffering film that is not affected by an object to be measured; measuring the reflection of the acoustic wave reflecting at the interface between the buffering film and the object to be measured; and comparing the two measured reflections to analyze at least one physical property of the interface.

In yet another aspect of the disclosure, an embodiment of the disclosure comprises a noninvasive measuring method for probing an interface, the method comprising the steps of: providing a transducer whose thickness is between approximately 1 nm to 10 nm and is covered by a buffering film to generate an acoustic wave with a frequency that is higher than approximately 300 GHz; calibrating with the measurement of the reflection of the acoustic wave reflecting at the interface between the buffering film and an object to be measured; measuring the reflection of the acoustic wave reflecting at the surface of the object to be measured free from the interface between the buffering film and the object; and comparing the two measured reflections to analyze at least one physical property of the interface.

### BRIEF DESCRIPTION OF THE DRAWINGS

Various objects to be measured and advantages of the present disclosure will be more readily understood from the following detailed description when read in conjunction with the appended drawings, in which:

FIG. 1 depicts a schematic diagram of a noninvasive measuring device for probing an interface according to an embodiment of the present disclosure;

FIGS. 2(a), 2(b), 2(c), and 2(d) depict several exemplary types of the sample used in an embodiment of the present disclosure;

FIGS. 3(a), 3(b), 3(c), and 3(d) depict the measurements of the reflection of the acoustic wave obtained from the samples shown in FIG. 2(a), FIG. 2(b), FIG. 2(c), or FIG. 2(d) according to an embodiment of the present disclosure;

FIG. 4 depicts an exemplary sample used for measuring an interface with ice according to an embodiment of the present disclosure;

FIG. 5(a) depicts the temporal trace of the measured results of the interface between the buffering film and the object to be measured and between the buffering film and vacuum before the object to be measured is installed or positioned on the buffering film according to an embodiment of the present disclosure;

FIG. 5(b) depicts the Fourier spectra of the interface before and after installing the object to be measured according to an embodiment of the present disclosure;

FIG. 6(a) depicts an exemplary sample used in the present embodiment;

FIG. 6(b) depicts another exemplary sample used in the present embodiment;

FIGS. 7(a) to 7(b) depict a comparison chart of the reflectivity or phase of the measured reflection of the acoustic wave versus two different theory curves, wherein one is the theory curve of interfacial water (marked by B) and the other is the theory curve of bulk water (marked by C) according to an embodiment of the present disclosure;

FIGS. 8(a) to 8(c) depict exemplary charts of several analyzed physical property of the interface;

FIG. 9 depict a flowchart for an embodiment of a noninvasive measuring method for probing an interface according to the disclosure; and

FIG. 10 depicts a flowchart for another embodiment of a noninvasive measuring method for probing an interface according to the disclosure.

### DESCRIPTION OF EMBODIMENTS OF THE INVENTION

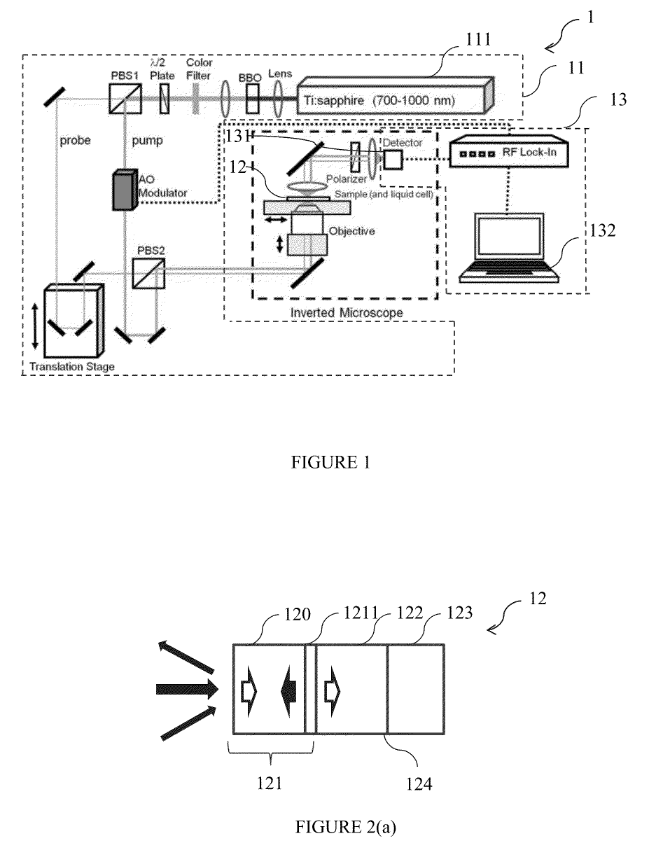

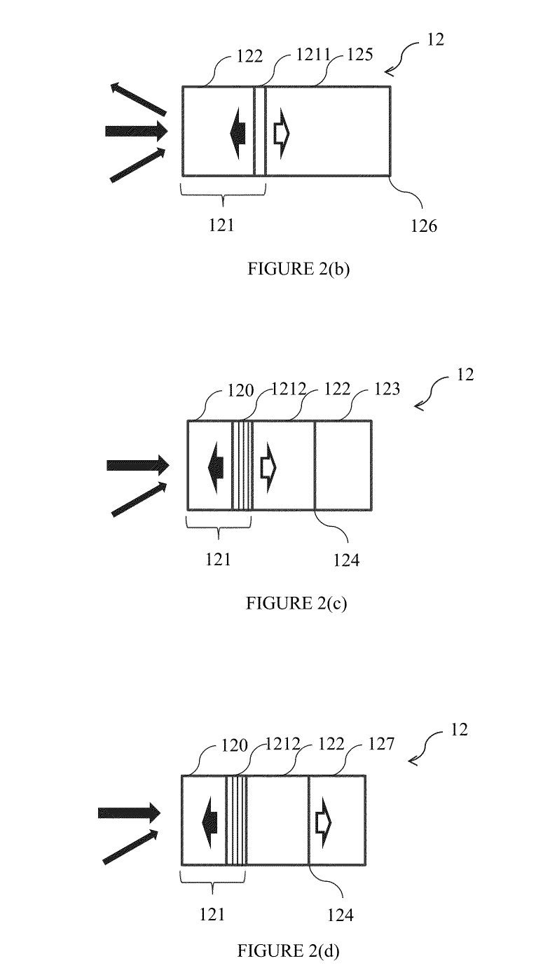

Please refer to FIGS. 1 and 2(a), wherein FIG. 1 shows a perspective view of a noninvasive measuring device for probing an interface according to an embodiment of the present invention, FIG. 2(a) shows a perspective view of a type of the sample used in the present embodiment. As shown, the noninvasive measuring device 1 comprises an optical unit 11, a sample 12 and a photo measuring unit 13. Please noted that here the optical unit 11 comprises an exemplary femtosecond laser source 111 which generates a plurality of coherent optical pumping pulses marked by bold lines and a plurality of coherent optical probing pulses marked by thin lines which is an inverse wave of the optical pumping pulses but delayed for a controllable time through a PBS (Polarizing Beam Splitter) cube. For adjusting the optical characters of the laser pulses, many optical devices are used here, such as doubling the frequency by a BBO (Betabarium-borate) crystal, controlling the beam path by mirrors, and controlling the focus by the objective lens, and so on. In other embodiments of the present invention, other structure or type of the optical unit may be used, and some of the elements inside the optical unit may be added or omitted. Outside of the sample 12, the thinner arrow directing to the sample 12 represents the optical probing pulses, the thicker arrow directing to the sample 12 represents the optical pumping pulses, and the arrow opposite to the sample 12 represents the reflection of the optical probing pulses and the optical pumping pulses.

The sample 12 comprises a GaN film 120, a transducer 121, a buffering film 122 covering the transducer 121, and an object to be measured 123 interfacing with the buffering film through an interface 124. The formation of the sample 12 is exemplarily accomplished by sequentially forming the GaN film 120, the transducer 121, the buffering film 122, the object to be measured 123 one by one through means of vapor deposition, sputtering, adhesive materials, mounting devices etc. The material of the transducer 121 to form at least one quantum well could be a semiconductor material or thin metal film, such as that chosen from the group of InGaN and InGaAs, and in the present embodiment, the transducer 121 is made of 3 nm thick InGaN forming a single quantum well 1211. The buffering film could be chosen from the group of GaN and GaAs, and in the present embodiment, the buffering film 122 is made of 7 nm thick n-type GaN. The object to be measured 123 is not limited to any state of fluid, solid and gas or any type of material, but for example, the object to be measured 123 could be any one of water, ice, sapphire, silicon and silicon oxide, and here is a sapphire substrate. When the optical pumping pulses and the optical probing pulses incident onto the free surface of the sample 12, i.e. the left surface shown in the figure, the transducer 121 receives the optical pumping pulses and the optical probing pulses, and the quantum well 1211 of the transducer 121 which forms lattice mismatch between the material of the transducer 121 and the buffering film 122 where stress is induced to generate a plurality of acoustic phonons. The acoustic phonons form an acoustic wave which frequency is higher than 300 GHz (marked by the hollow arrows) and an inverse acoustic wave which is not shown inside the sample 12 in the figure. Here, in the present embodiment, preferably, the frequency of the acoustic wave is about 1 THz, such as 890 GHz used here, or over 1 THz, for example, 1.4 THz. These acoustic wave and inverse acoustic wave generate inverse piezoelectric coupling inside the sample 12 to affect the optical transmission of the interface between the buffering film 122 and the object to be measured 123. Through the inverse piezoelectric effect, the acoustic wave could be detected.

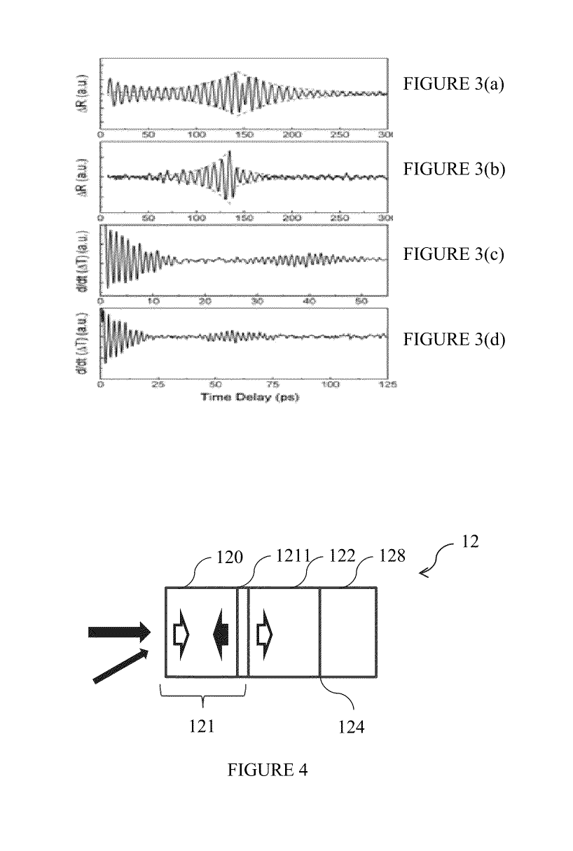

Please refer to FIG. 3(a) for the measurement of the reflection of the acoustic wave obtained from the sample 12 shown in FIG. 2(a). With the ultrasound frequency of the acoustic wave, the photo measuring unit 13 comprising a photo detector 131 and an analyzing element 132 could measure the reflection of the acoustic wave (marked by the concrete arrow pointed to the left in the figure), such as the change of transmission, the change of reflectivity of the reflection of the acoustic wave or other optical property, reflecting from the interface 124 where the acoustic wave interacts with the object to be measured 123 and the buffering film 122 to analyze at least one physical property of the interface 124 with 0.3 nm resolution within 30 ps. The analyzed physical property comprises: acoustic attenuation, surface roughness, loss spectrum, mass density, elastic modulus, and bulk viscosity. Here, from the specular scattering probability of acoustic phonons at crystal boundary, which is induced by roughness of the interface 124, the nanoscaled irregularity, roughness, of the interface 124 could be noninvasively analyzed. Additionally, for a more conscientious result, before forming the object to be measured 123, it is preferably to carry on calibration first, for example calibration with the measurement of the reflection of the acoustic wave, which is not affected by an object to be measured 123, reflecting from the right surface of the buffering film 122 where is predetermined to form the object to be measured 123. Then, this measurement for calibration can be compared with the measurement of the reflection of the acoustic wave after forming the buffering film 122.

Please refer to FIGS. 2(b), 2(c), and 2(d) and FIGS. 3(b), 3(c), and 3(d), wherein FIGS. 2(b), 2(c), and 2(d) shows perspective views of other types of the sample used in the present embodiment, and FIGS. 3(b), 3(c), and 3(d) show the measurement of the reflection of the acoustic wave obtained from the sample 12 shown in FIG. 2(b), FIG. 2(c), or FIG. 2(d) accordingly. For a clear comparison, the differences between these types of the sample 12 and what is shown in FIG. 2(a) are: in the sample 12 shown in FIG. 2(b), the object to be measured 125 is a silicon substrate attached on the opposite surface of the buffering film 122, which is made of GaN, and the acoustic wave reflects at the free surface 126 which is the interface between the silicon substrate and air; in the sample 12 shown in FIG. 2(c), the object to be measured 123 is still a sapphire substrate, but the transducer 121 is made of several layers of semiconductor material, such as InGaN, forming a multi-quantum well 1212; in the sample shown in FIG. 2(d), the object to be measured 123 is a silicon oxide film 127.

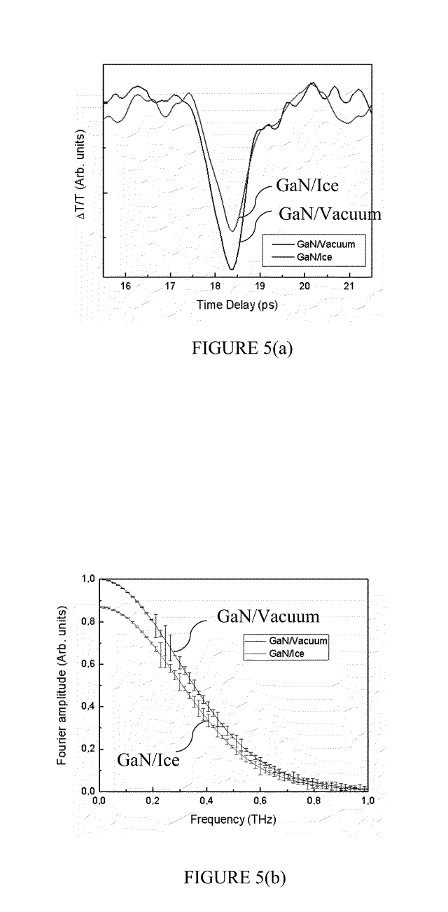

Please refer to FIGS. 4, 5(a), and 5(b) for another embodiment of the present invention, wherein FIG. 4 shows a perspective view of a sample used for measuring an interface with ice 128, FIG. 5(a) shows the temporal trace of the measured results, i.e. the change of the transmittance, of the interface 124 between the buffering film 122 and the object to be measured 128, i.e. ice, and between the buffering film 122 and vacuum before the object to be measured 128 is installed or positioned on the buffering film 122, and FIG. 5(b) shows the Fourier spectra of the interface 124 before and after installing the object to be measured 128. Please noted that the transducer 1211 forms a single quantum well in the present embodiment; however, multi-quantum well or other types of transducer to generate phonons is also applicable. As shown in FIG. 5(b), the acoustic reflection spectra is a complex which could be derived based on the formula as follows:

$$R ( ω ) = \frac{{Z}_{GaN} ( ω ) - {Z}_{Ice} ( ω )}{{Z}_{GaN} ( ω ) + {Z}_{Ice} ( ω )}$$

wherein Z designates a complex acoustic impedance, and it relates to ρ (mass density) through Z=ρ V_{complex}, wherein V_{complex} designates acoustic velocity, which could be derived based on the formula as follows:

$${V}_{complex} ( ω ) = \frac{ω}{k ( ω ) - i α ( ω )}$$

Additionally, according to Stoke's Law:

$$ρ \frac{{\partial }^{2} u}{\partial {t}^{2}} = A \frac{{\partial }^{2} u}{\partial {x}^{2}} + b \frac{{\partial }^{2}}{\partial {x}^{2}} \frac{\partial u}{\partial t}$$

wherein A represents elastic modulus and b represents bulk viscosity, with the dispersion relation and loss spectrum relation listed bellow:

$${k}^{2} = \frac{{ω}^{2} ρ}{2 A} [ \frac{1}{\sqrt{1 + {ω}^{2} {τ}^{2}}} + \frac{1}{1 + {ω}^{2} {τ}^{2}} ]$$

$${α}^{2} = \frac{{ω}^{2} ρ}{2 A} [ \frac{1}{1 + {ω}^{2} {τ}^{2}} - \frac{1}{1 + {ω}^{2} {τ}^{2}} ]$$

the curves of mass density, elastic modulus, and bulk viscosity can be analyzed.

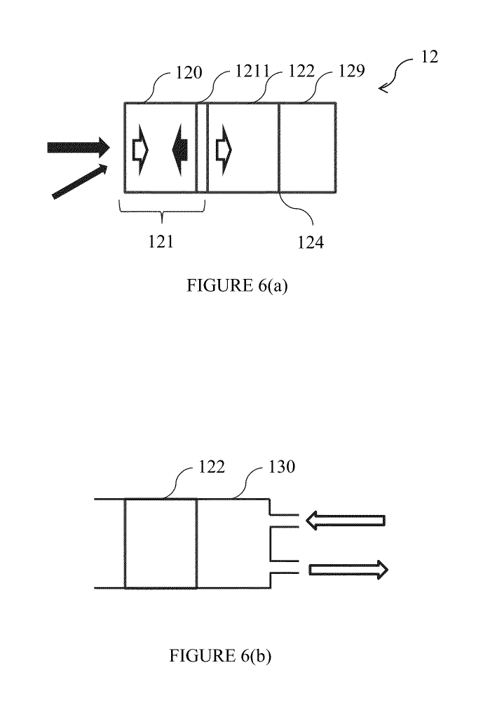

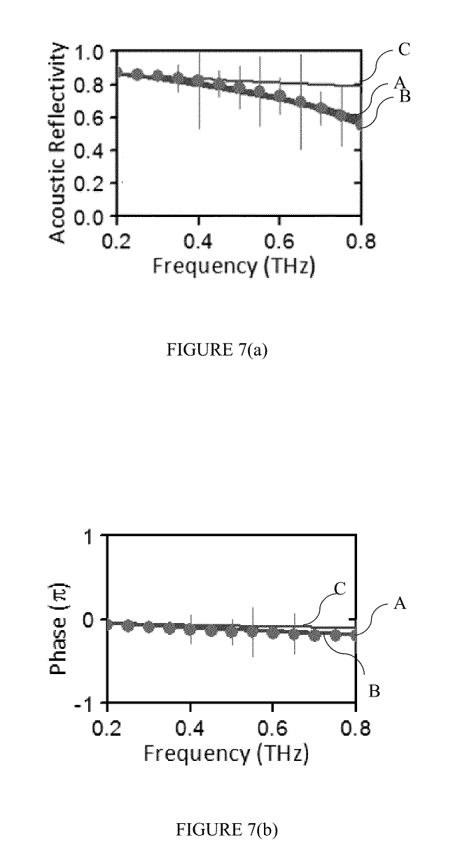

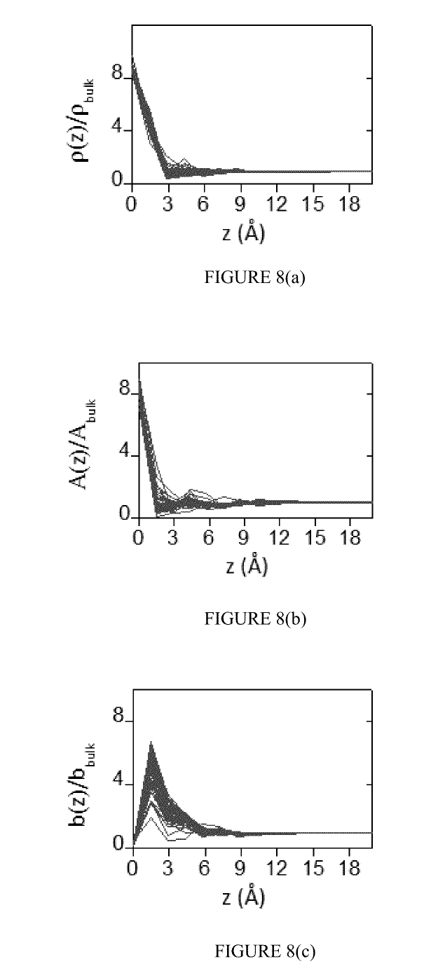

Please refer to FIGS. 6(a), 6(b), 7(a), 7(b), 8(a), 8(b), and 8(c) for yet another embodiment of the present invention, wherein FIG. 6(a) shows a perspective view of a sample used in the present embodiment, FIG. 6(b) shows another perspective view of a sample used in the present embodiment, FIGS. 7(a) to 7(b) show a comparison chart of the reflectivity or phase of the measured reflection of the acoustic wave (marked by A) versus two different theory curves, one is the theory curve of interfacial water (marked by B) and the other is the theory curve of bulk water (marked by C), and FIGS. 8(a) to 8(c) show exemplary charts of several analyzed physical property of the interface 124, i.e. the interfacial water around the interface 124. As shown in FIG. 6(a), the object to be measured 129, i.e. water or fluid, interfaces with the buffering film 122, 80 nm thick GaN, by interface 124 in the present embodiment. For controlling the water or fluid, a tank 130 with an inlet and an outlet, as shown in FIG. 6(b), can be used. When measuring the reflection of the acoustic wave which frequency could be in the range of 300 GHz to 1.4 THz, the water or fluid could flow in the tank 130. Here, the curves of mass density, elastic modulus, and bulk viscosity are shown in FIGS. 8(a) to 8(c) respectively.

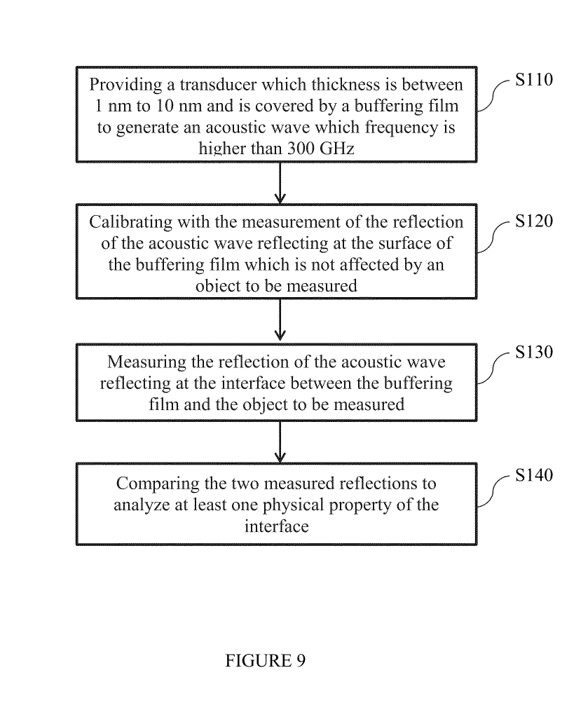

Please refer to FIG. 9 for an embodiment of a noninvasive measuring method for probing an interface according to the invention. To understand an exemplary system structure applying the method of the present embodiment, please also refer to FIGS. 1, 2(a) and 3(a); however, the method of the present embodiment is not limited to the system structure shown in FIGS. 1, 2(a) and 3(a). The noninvasive measuring method for probing an interface in the present embodiment comprises the steps of providing a transducer which thickness is between 1 nm to 10 nm and is covered by a buffering film to generate an acoustic wave which frequency is higher than 300 GHz (Step S110); calibrating with the measurement of the reflection of the acoustic wave reflecting at the surface of the buffering film which is not affected by an object to be measured (Step S120); measuring the reflection of the acoustic wave reflecting at the interface between the buffering film and the object to be measured (Step S130); and comparing the two measured reflections to analyze at least one physical property of the interface (Step S140). Please refer to related paragraphs in the previous embodiment for understanding the generation of acoustic wave, reflection of acoustic wave, measurement of the reflection of the acoustic wave, and the analyzed physical property.

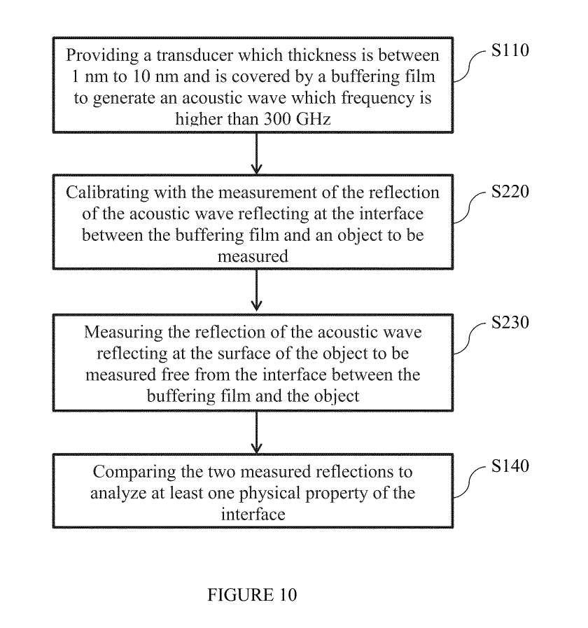

Please refer to FIG. 10 for another embodiment of a noninvasive measuring method for probing an interface according to the invention. To understand an exemplary system structure applying the method of the present embodiment, please also refer to FIGS. 1, 2(b) and 3(b). The noninvasive measuring method for probing an interface in the present embodiment comprises the steps of providing a transducer which thickness is between 1 nm to 10 nm and is covered by a buffering film to generate an acoustic wave which frequency is higher than 300 GHz (Step S110); for a more conscientious result of attenuation loss of the reflection of the acoustic wave propagating back from the free surface of the object to be measured, the calibration is carried out with the measurement of the reflection of the acoustic wave reflecting at the interface between the buffering film and an object to be measured first (Step S220); then, measuring the reflection of the acoustic wave reflecting at the surface of the object to be measured free from the interface between the buffering film and the object (Step S230); and comparing the two measured reflections to analyze at least one physical property of the interface (Step S140).

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims. For instance, it is possible to add bus buffers on a specific data bus if it is necessary. Moreover, it is still possible to have a plurality of bus buffers cascaded in series.

What is claimed is:

1. A noninvasive measuring method for probing an interface, the method comprising: providing a transducer whose thickness is between about 1 nm to 10 nm and is covered by a buffering film operable to generate an acoustic wave whose frequency is higher than about 300 GHz; calibrating with a measurement of a reflection of the acoustic wave reflecting at an interface between the buffering film and an object to be measured; measuring a reflection of the acoustic wave reflecting at a surface of the object to be measured free from the interface between the buffering film and the object to be measured; and comparing the two measured reflections to analyze at least one physical property of the interface.

2. The noninvasive measuring method according to claim 1, further comprising: generating a plurality of optical pumping pulses; and generating a plurality of optical probing pulses; wherein the transducer is operable to receive the optical pumping pulses in order to generate the acoustic wave and the optical probing pulses, wherein the optical probing pulses are an inverse wave of the optical pumping pulses and are operable to be delayed for a controllable time in order to generate an inverse acoustic wave.

3. The noninvasive measuring method according to claim 1, wherein providing the transducer further comprises: forming at least one quantum well by a semiconductor material that is operable to form a lattice mismatch between the buffering film and the semiconductor material where stress is operable to induce and generate a plurality of acoustic phonons.

4. The noninvasive measuring method according to claim 1, wherein the object to be measured comprises any one of water, ice, sapphire, silicon, and silicon oxide.

5. The noninvasive measuring method according to claim 1, wherein the measurement of the reflection of the acoustic wave is one of the change of transmission or the change of reflectivity of the reflection of the acoustic wave.

6. The noninvasive measuring method according to claim 1, wherein the analyzed physical property comprises one of: acoustic attenuation, surface roughness, spectrum loss, mass density, elastic modulus, and bulk viscosity.

7. The noninvasive measuring method according to claim 1, wherein the frequency of the acoustic wave is within the range from about 300 GHz to 1.4 THz.
